(19) United States
(12) Patent Application Publication
(10) Pub. No.: US 2010/0015506 A1
(43) Pub. Date: Jan. 21, 2010

(54) CATALYST MATERIAL AND PROCESS FOR PREPARING THE SAME

(75) Inventors: Naoko Iwata, Aichi (JP); Makoto Yuasa, Saitama (JP); Kenichi Oyaizu, Tokyo (JP); Ken Tanaka, Saitama (JP); Yuichi Iai, Tokyo (JP); Masakuni Yamamoto, Tochigi (JP); Shinichi Sasaki, Miyagi (JP); Shigeru Kido, Fukushima (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KAISHA, Toyota-shi, Aichi (JP)

(21) Appl. No.: 12/523,879

(22) PCT Filed: Jan. 22, 2008
(86) PCT No.: PCT/JP2008/051147

§ 371 Date: Jul. 21, 2009

(30) Foreign Application Priority Data
Jan. 22, 2007 (JP) 2007-011404

(51) Int. Cl. H01M 4/00; B01J 31/18; B01J 31/00

(52) U.S. Cl. 429/43; 502/167; 502/152

(57) ABSTRACT

A catalyst material that bears active species densely, thereby having higher catalytic performance and serviceability, for example, as an electrode for fuel cells. A catalyst material, wherein a conductive material whose surface physically adsorbs a polymerizable ligand having an electrochemically polymerizable heterocycle and an electron-withdrawing group bonded to the heterocycle or is coated with polynuclear complex molecules formed by electrochemical polymerization of the polymerizable ligand having an electrochemically polymerizable heterocycle and an electron-withdrawing group bonded to the heterocycle. A catalytic metal is coordinated to the adsorption layer of the polymerizable ligand having an electrochemically polymerizable heterocycle and an electron-withdrawing group bonded to the heterocycle, or to the coating layer of the polynuclear complex molecules.

### TECHNICAL FIELD

The present invention relates to a catalyst material and a process for preparing the same, in particular, to a catalyst material that bears active species densely, thereby having high catalytic activity and being suitable as a catalyst for fuel cells and a process for preparing the same.

### BACKGROUND ART

Recently, many investigations have been made of electrode systems, as electrode catalysts, which have undergone surface modification with a macrocyclic compound, such as porphyrin, chlorophyll, phthalocyanine, tetraazaannulene or Schiff base, or a derivative thereof. These electrode systems are expected to be applied, as electrode catalysts which take the place of platinum (Pt) and its alloys, to the cathode of (oxygen-hydrogen) fuel cells, such as phosphoric acid fuel cells or polymer electrolyte fuel cells, by utilizing the electrochemical multielectron reduction properties of molecular oxygen (O₂) due to such electrode catalysts (see “Hyomen Gijutsu (Surface Finish. Soc. Jpn.)”, vol. 46, No. 4, 19-26 and “POLYMERS FOR ADVANCED TECHNOLOGYS”, No. 12, 266-270 (2001)).

However, the catalytic activity of the electrode systems utilizing any of the above macrocyclic compounds is insufficient to use for fuel cells. Under these circumstances, there have been demands for development of catalyst materials having higher catalytic performance and serviceability.

[Non-Patent Document 1] “Hyomen Gijutsu (Surface Finish. Soc. Jpn.)”, vol. 46, No. 4, 19-26 and “POLYMERS FOR ADVANCED TECHNOLOGYS”, No. 12, 266-270 (2001))

### DISCLOSURE OF THE INVENTION

It is therefore the object of the present invention to provide a catalyst material that bears specified active species, thereby having higher catalytic performance and serviceability, particularly as electrode for fuel cells and the like.

To solve the above problem, first, the present inventors examined the reasons that the electrode catalysts utilizing a macrocyclic compound do not have sufficiently high catalytic activity. As a result, they inferred from the examination that in the catalyst systems utilizing a macrocyclic compound, the density of active species is lowered when the species are supported on a catalyst support, whereby the catalytic activity of the catalyst systems is decreased. The present inventors have found through the examination that if a catalyst support is coated with a heteromonocyclic compound or a polynuclear polymer derived from the heteromonocyclic compound, a lot of M-N4 structure where a catalytic metal is coordinated is formed, whereby a catalyst material having high catalytic activity is obtained.

Thus, the present inventors have found that the above problem can be solved by a catalyst material including a conductive material whose surface is coated with a polynuclear polymer formed by polymerization of a specific monomer, characterized in that the specific monomer or the polynuclear polymer formed by polymerization of the specific monomer is used as a polymerizable ligand and a catalytic metal is coordinated to the coordination sites of the polymerizable ligand. And they have finally reached the present invention.

After dedicating their efforts to this investigation, the present inventors have found that when the polymerizable ligand is a ligand obtained by electrochemical polymerization under the specified conditions (voltage applied, solvent, supporting electrolyte), the resultant catalyst material bears active species densely and has significantly improved catalytic activity, and they have reached the present invention. Further, after examining the characteristics of the conductive materials to be used as a support, the present inventors have found that when the conductive material has a specified specific surface area and average particle size, the resultant catalyst material has significantly improved catalytic activity, and they have reached the present invention. Further, they have found that repeating the electrochemical polymerization and/or the coordination of a catalytic metal (metallation) more than one time is effective in increasing the density of active species supported on a catalyst support and improving the catalytic activity of the catalytic material, and they have reached the present invention. Further, they have found that using an ancillary ligand when repeating the electrochemical polymerization and/or the coordination of a catalytic metal (metallation) more than one time is effective in improving the coordination property of a catalytic metal, and they have reached the present invention. Further, they have found that when a noble metal and a transition metal are coordinated to the coating layer at the same time, the resultant catalyst material has significantly improved catalytic activity, and they have reached the present invention.

First, the present invention provides a catalyst material, including a conductive material whose surface physically adsorbs a polymerizable ligand having an electrochemically polymerizable heterocycle and an electron-withdrawing group bonded to the heterocycle or is coated with polynuclear complex molecules formed by electrochemical polymerization of the polymerizable ligand having an electrochemically polymerizable heterocycle and an electron-withdrawing group bonded to the heterocycle, characterized in that a catalytic metal is coordinated to the adsorption layer of the polymerizable ligand having an electrochemically polymerizable heterocycle and an electron-withdrawing group bonded to the heterocycle or to the coating layer of the polynuclear complex molecules.

As the polymerizable ligand having an electrochemically polymerizable heterocycle and an electron-withdrawing group bonded to the heterocycle, various types of compounds can be used depending on the combination of an electrochemically polymerizable heterocycle and an electron-withdrawing group bonded to the heterocycle. Preferable examples of such compounds include 2-(1H-pyrrol-3-ylpyridine), where pyrrole is selected as a heterocycle and pyridine as an electron-withdrawing group bonded to the heterocycle.

Second, the present invention provides a process for preparing the above catalyst material, characterized in that it includes the steps of: allowing the surface of a conductive material to physically adsorb a polymerizable ligand having an electrochemically polymerizable heterocycle and an electron-withdrawing group bonded to the heterocycle or allowing the surface of a conductive material to be coated with polynuclear complex molecules formed by electrochemical polymerization of the polymerizable ligand having an electrochemically polymerizable heterocycle and an electron-withdrawing group bonded to the heterocycle; and then coordinating a catalytic metal to the adsorption layer of the polymerizable ligand having an electrochemically polymerizable heterocycle and an electron-withdrawing group bonded to the heterocycle or to the coating layer of the polynuclear complex molecules.

Preferable examples of polymerizable ligands having an electrochemically polymerizable heterocycle and an electron-withdrawing group bonded to the heterocycle include 2-(1H-pyrrol-3-ylpyridine), as described above.

In the present invention, to improve the catalytic activity, preferably the process further includes a burning step, after the above catalytic metal coordination step, of burning the catalyst material after the coordination step at 400 to 800° C. in an atmosphere of an inert gas.

In the present invention, preferably the electrochemical polymerization step of electrochemically polymerizing 2-(1H-pyrrol-3-ylpyridine) to yield a polynuclear complex molecules and coating the surface of a conductive material with the polynuclear complex molecules is carried out at an applied potential of 0.8 to 1.5 V.

In the process for preparing a catalyst material of the present invention which includes: an electrochemical polymerization step of electrochemically polymerizing a polymerizable ligand having an electrochemically polymerizable heterocycle and an electron-withdrawing group bonded to the heterocycle and coating the surface of a conductive material with the polynuclear polymer derived from the polymerizable ligand; and a metallation step of coordinating a catalytic metal to the coating layer of the polynuclear polymer, the electrochemical polymerization step and/or the metallation step can be carried out only one time or more than one time. Carrying out the electrochemical polymerization step and/or the metallation step more than one time makes it possible to increase the density of supported active species, leading to a higher catalytic activity.

In the present invention, the coordination of a catalytic metal can be performed using a noble metal and/or a transition metal which is known in various catalyst areas, and if a noble metal and a transition metal are coordinated at the same time, the resultant catalyst material may have improved catalytic activity. Specifically, preferable examples of the previous metal include one or more selected from the group consisting of palladium (Pd), iridium (Ir), rhodium (Rh) and platinum (Pt); and those of the transition metal include one or more selected from the group consisting of cobalt (Co), iron (Fe), molybdenum (Mo) and chromium (Cr).

In the present invention, it is effective in improving the catalytic activity of the resultant catalyst material to heat treat (burn) the catalyst material after the coordination of a catalytic metal. The catalytic activity of the resultant catalyst material can be significantly improved by heat treatment (burning). The specific conditions under which heat treatment (burning) is carried out vary depending on the catalyst components and the heating temperature; however, heat treatment is preferably carried out, for example, at 400 to 700° C. for 2 to 4 hours.

In the present invention, it is effective in enhancing the coordination property of a catalyst and increasing the density of the polynuclear coordination molecules supported as active species to coordinate a low-molecular-weight heterocyclic compound, as an ancillary ligand, to the catalytic metal when coordinating the catalytic metal to the adsorption layer of the polymerizable ligand having an electrochemically polymerizable heterocycle and an electron-withdrawing-group bonded to the heterocycle or the coating layer of the polynuclear complex molecules.

In the present invention, the term “ancillary ligand” means a low-molecular-weight compound that has the function of more completely achieving the coordination of a catalytic metal by assisting in coordinating “the polynuclear polymer derived from a heteromonocyclic compound” to the catalytic metal. Preferable examples of such ancillary ligands include low-molecular-weight heterocyclic compounds. Use of an ancillary ligand makes it possible to further improve the catalytic activity of a catalyst material. For example, it is preferable from the viewpoint of promoting the coordination of a catalytic metal to further coordinate, as an ancillary ligand, a nitrogen-containing low-molecular-weight compound as a low-molecular-weight heterocyclic compound to the catalytic metal. As the nitrogen-containing low-molecular-weight compound, any one of various kinds of compounds is used. And as the low-molecular-weight heterocyclic compound, any one of various kinds of compounds is used. Of the low-molecular-weight heterocyclic compounds, preferable are pyridine, which have one nitrogen atom as a hetero atom, and phenanthroline, which has two nitrogen atoms as hetero atoms.

Thirdly, the present invention provides a catalyst for fuel cells which is made up of the above catalyst material. The noble metal employed for the catalyst material of the present invention is not limited to any specific noble metal, and any metal known as catalyst material for fuel cells can be used. The combination of noble metals and transition metals can also be used. Preferable examples of combinations of noble metals and transition metals include combinations of: one or more kinds of noble metals selected from the group consisting of palladium (Pd), iridium (Ir), rhodium (Rh) and platinum (Pt); and one or more kinds of transition metals selected from the group consisting of cobalt (Co), iron (Fe), molybdenum (Mo) and chromium (Cr). Of these combinations, particularly preferable are the combination of iridium (Ir), as a noble metal, and cobalt (Co), as a transition metal, the combination of rhodium (Rh), as a noble metal, and cobalt (Co), as a transition metal, and the combination of palladium (Pd), as a noble metal, and cobalt (Co), as a transition metal.

Fourthly, the present invention provides a fuel cell which includes the above catalyst material as a catalyst for fuel cells.

In the present invention, examples of the electrochemically polymerizable heterocycles described above include heteromonocyclic compounds, and of such compounds, preferable examples include monocyclic compounds each having, as a basic skeleton, pyrrole, dimethylpyrrole, pyrrole-2-carboxyaldehyde, pyrrole-2-alcohol, vinylpyridine, aminobenzoic acid, aniline or thiophene. Examples of polynuclear polymer portions obtained by electrochemically polymerizing these electrochemically polymerizable heterocycles preferably include: polypyrrole complexes, polyvinylpyridine complexes, polyaniline complexes and polythiophene complexes. The processes for electrochemically polymerizing electrochemically polymerizable heterocycles are known from various known documents.

In the present invention, preferably the electrochemical polymerization step is carried out in any of various known solvents and particularly preferably in a water-methanol or water-ethanol mixed solvent.

Further, preferably the electrochemical polymerization step is carried out using NH₄ClO₄ or PTS as a supporting electrolyte.

In the present invention, preferably the conductive material, as a support for the catalyst material, has a specific surface area of 500 to 2000 m²/g and more preferably 800 to 1500 m²/g. Also preferably the conductive material has an average particle size of 3 to 30 μm and more preferably 3 to 10 nm.

Preferably the process for preparing a catalyst material of the present invention also includes a heat treatment step to be carried after the metallation step.

In the present invention, when both noble metal and transition metal are coordinated to the catalyst, the content of the noble metal in the catalyst material having the catalytic metal is preferably 20 to 60 wt %. If the content of the noble metal is in such a range, the catalyst material may have improved catalyst activity.

In the present invention, preferably the raw material for the catalyst material that contains composite catalytic metals as described above is highly purified. If the raw material for the catalyst material is highly purified, the catalytic activity is significantly improved. One example of methods for highly purifying the raw material for the catalyst material is that palladium acetate is used as a raw palladium material, for example, and the purity of the palladium acetate is increased by a known physical or chemical method. The reason that the catalytic activity is improved by the purification of the raw material for the catalyst material has not been fully clarified yet, but the improvement may be attributed to significant increase on the surface of N, Co, Pd, etc., which form the active sites, particularly to a significant increase of Pd introduced.

In the present invention, preferable examples of conductive materials as described above include metals, semiconductors, carbon-based compounds and conductive polymers.

Preferably the catalyst material of the present invention includes a second metal and/or its ions as well as the above catalytic metal. It is also preferable from the viewpoint of improving the activity to dope the catalyst material with anion.

The shape of the catalyst material of the present invention is not limited to any specific one. For example, it can be a particle-like, fiber-like, hollow, or corned horn-like material.

The catalyst material of the present invention is a material prepared by coordinating a catalytic metal to a specific compound to support the catalytic metal in high density. The material has an excellent catalytic activity, and when used as a catalyst for fuel cells, it can improve the power generation performance of fuel cells.

### BRIEF DESCRIPTION OF THE DRAWING

FIG. 1 is a flow diagram of the preparation of a catalyst material of Example 1 using 2-(1H-pyrrol-3-ylpyridine) as a polymerizable ligand.

### BEST MODE FOR CARRYING OUT THE INVENTION

The catalyst material of the present invention is a material prepared by allowing the surface of a conductive material to physically adsorb a polymerizable ligand having a electrochemically polymerizable heterocycle and an electron-withdrawing group bonded to the heterocycle and coordinating a catalytic metal to the coordination sites of the adsorbed polymerizable ligand.

Further, the catalyst material of the present invention is a material prepared by coating the surface of a conductive material with a polynuclear polymer obtained by electrochemically polymerizing a polymerizable ligand having an electrochemically polymerizable heterocycle and an electron-withdrawing-group bonded to the heterocycle and coordinating a catalytic metal to the coordination sites of the coating layer.

Preferable examples of polymerizable ligands having an electrochemically polymerizable heterocycle and an electron-withdrawing-group bonded to the heterocycle include 2-(1H-pyrrol-3-ylpyridine), where pyridine, which has a strong coordination property to Co or the like, and pyrrole, which is electrochemically polymerizable, are bonded together.

Examples of conductive materials usable for the catalyst material of the present invention include: metals such as platinum, gold, silver and stainless steel; semiconductors such as silicon; carbon-based materials such as glassy carbon, carbon black, graphite and activated carbon; and conductive polymers such as polyaniline, polypyrrole and polythiophene. From the view point of availability, cost, weight, etc., preferably a carbon-based material such as glassy carbon, carbon black, graphite or activated carbon is used as the conductive material. From the viewpoint of ensuring a large surface area, the conductive material is preferably a particle-like, fiber-like, hollow, or corned horn-like material, though it can be a sheet-like or rod-like material.

As a particle-like conductive material, materials having an average particle size of 3 to 30 nm are preferable and materials having an average particle size of 3 to 10 nm are more preferable. As a fiber-like, hollow or cored horn-like conductive material, carbon fiber (filler), carbon nanotube or carbon nanohorn is preferable.

The polynuclear polymer that coats the conductive material is derived from a heteromonocyclic compound. Examples of heteromonocyclic compounds usable as a raw material include: monocyclic compounds each having pyrrole, vinylpyridine, aniline or thiophene as a basic skeleton. More specifically, pyrrole, dimethylpyrrole, pyrrole-2-carboxyaldehyde, pyrrole-2-alcohol, vinylpyridine, aniline, aminobenzoic acid, thiophene or the like is used as the heteromonocyclic compound.

Examples of catalytic metals which can be coordinated to the coordination sites of the polynuclear polymer include: one or more kinds of noble metals selected from the group consisting of palladium (Pd), iridium (Ir), rhodium (Rh) and platinum (Pt); and one or more kinds of transition metals selected from the group consisting of cobalt, iron, molybdenum and chromium and iridium, which are made into composites with the noble metal(s).

A process for deriving a polynuclear polymer from a polymerizable ligand having an electrochemically polymerizable heterocycle and an electron-withdrawing-group bonded to the heterocycle and coating a conductive material with the polynuclear polymer can be established by electrochemical polymerization. The electrochemical polymerization process is a process in which a heteromonocyclic compound is electrochemically polymerized on a conductive material so that the conductive material is coated with the resulting polynuclear polymer and then a catalytic metal is allowed to act on the polynuclear polymer so that the coordination sites of the polynuclear polymer (when the polynuclear polymer is a nitrogen-containing complex compound, the M-N₄ structure sites) support the catalytic metal.

When the conductive material is a commonly used sheet-like or rod-like material, the electrochemical polymerization of a heteromonocyclic compound on the conductive material can be carried out using conventional apparatus for electrochemical polymerization under conventional conditions. However, when the conductive material used is a fine particle-like, fiber-like, hollow or corned horn-like material, it is effective to use fluidized bed electrode apparatus for electrochemical polymerization.

To allow a solution containing a catalytic metal to act on the conductive particles coated with the polynuclear polymer obtained by electrochemical polymerization (hereinafter referred to as “coated particles”), for example, the coated particles are suspended in a proper solution in which the catalytic metal is dissolved and the suspension is refluxed with heat under an inert gas atmosphere.

The coordination compounds used in the present invention take the form in which the hetero atoms of the heteromonocyclic compounds (nitrogen atoms when the compounds are pyrrole and aniline, sulfur atoms when the compound is thiophene) are coordinated to the catalytic metal atom. And if any of the coordination compounds is physically adsorbed on a conductive material, the surface of the conductive material is coated with catalytic metal-supporting polymerizable ligands and the catalytic metal. And if any of the coordination compounds is electrochemically polymerized on a conductive material, the surface of the conductive material is coated with polynuclear complex molecules composed of a catalytic metal-supporting polynuclear polymer.

When the conductive material is a commonly used sheet-like or rod-like material, the electrochemical polymerization of any of the above coordination compounds on the conductive material can be carried out using a conventional apparatus for electrochemical polymerization under conventional conditions. However, when the conductive material used is a fine particle-like, fiber-like, hollow or corned horn-like material, it is necessary to use a fluidized bed electrode apparatus for electrochemical polymerization in the same manner as described above. The electrochemical polymerization process using a fluidized bed electrode apparatus for electrochemical polymerization can be carried out in almost the same manner as described above, except that any one of solvents capable of dissolving the above coordination compounds is used. Of such solvents, a mixed solvent of water-methanol or water-ethanol is suitably used.

Ideally, 4 nitrogen atoms or sulfur atoms in heterocycles are coordinated to one metal. In an actual polymerizable ligand or polynuclear polymer derived from a polymerizable ligand, 4 nitrogen atoms or sulfur atoms in heterocycles are not always coordinated to one metal because of the assembly characteristics, bending state or steric hindrance of its molecules. However, even in cases where only 3 or 2 nitrogen atoms or sulfur atoms are coordinated to one metal, addition of a low-molecular-weight heterocyclic compound to the reaction system enables the low-molecular-weight heterocyclic compound to act as an ancillary ligand to coordinate to the metal additionally.

The catalyst material of the present invention obtained as above, which is coated with a polymerizable ligand or polynuclear complex molecules consisting of a polymerizable ligand to which a catalytic metal is coordinated has an excellent catalytic activity, compared with an electrode material having its surface modified with a macrocyclic compound such as porphyrin. And the catalyst material can be used as a catalyst which takes the place of platinum (Pt) or its alloys, for example, as an electrode catalyst for cathodes of various types of fuel cells.

An electrode catalyst material for cathodes (oxygen or air electrodes) of fuel cells is required to have catalytic action on the oxygen reduction reactions as shown below, thereby accelerating such reactions. Specifically, when oxygen (O₂), proton (H⁺) and electron (e⁻) are supplied, the oxygen reduction reaction, such as 4-electron reduction of oxygen expressed by the following reaction formula (1) or the 2+2-electron reduction of oxygen expressed by the following reaction formulae (2) and (3), is accelerated through the catalysis of the catalyst material at an effective noble potential.

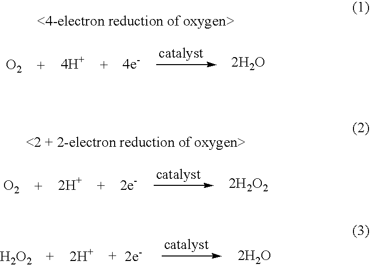

In the present invention, the peak potential of oxygen reduction obtained by cyclic voltammetry (cv) and rotating disk electrode (RDE) measurement is 0.54 V vs. SCE and the number of the electrons involved in the reaction is close to 4, as described later. This performance is comparable to the catalyst performance of platinum or its alloys which are currently used as an electrode catalyst material for the cathodes (oxygen or air electrodes) of fuel cells. This clearly shows that the catalyst material of the present invention can be used as an electrode catalyst material for the cathodes (oxygen or air electrodes) of fuel cells.

The catalyst material of the present invention, which is obtained as above, preferably contains a second metal as the other metal element and/or its ion. Examples of the second metals and/or their ions available here include: nickel, titanium, vanadium, chromium, manganese, iron, copper, zinc, zirconium, niobium, molybdenum, ruthenium, rhodium, palladium, silver, cadmium, tungsten, osmium, iridium, platinum, gold and mercury. Of these metals and/or their ions, nickel (Ni) is particularly preferably used. The catalyst material containing a second metal and/or its ion can be prepared by adding a second metal and/or its ion when coordinating a catalytic metal, such as cobalt, to the coordination sites which are made up of polynuclear complex molecules. For example, the catalyst material containing a second metal and/or its ion of the present invention can be prepared by refluxing the conductive material coated with a heteromonocyclic compound, cobalt acetate and nickel acetate in a methanol solution.

If the catalyst material of the present invention contains a second metal and/or its ion, its oxidation reduction performance is more improved. Thus, the catalyst material containing a second metal and/or its ion has a sufficient catalytic performance required when it is used for fuel cells etc., and thus can be used in practice.

In preparation of a catalyst material of the present invention, it is preferable to heat treat (burn) the catalyst material obtained by coordinating a catalytic metal to coordination sites, which are formed by polymerizable ligands or the polynuclear polymer derived from polymerizable ligands. And it is more preferable to carry out the heat treatment (burning) in an atmosphere of an inert gas.

Specifically, a catalyst material including a polynuclear polymer is prepared by allowing a conductive material to physically adsorb a polymerizable ligand or electrochemically polymerizing a polymerizable ligand to yield a polynuclear polymer so that a conductive material is coated with the polynuclear polymer and then allowing a catalytic metal to act on the coating layer so that the catalytic metal is coordinated to the coating layer, as described above. In this process, it is preferable to heat treat (burn) the catalytic material after coordinating the catalytic metal.

This heat treatment (burning) is carried out, for example, in such a manner that the temperature of the catalyst material is increased from the starting temperature (usually, ambient temperature) to a preset temperature, kept at the preset temperature for a certain period of time, and decreased little by little. The treatment temperature used in this heat treatment (burning) means the preset temperature at which the catalyst material is kept for a certain period of time. For example, the cell is evacuated to a desired pressure while being kept at the starting temperature, heated at a heating rate of 5° C./min to a preset temperature T (T=about 400 to 700° C.), kept at the preset temperature T for about 2 to 4 hours, and cooled to room temperature over about 2 hours.

As described above, heat treating (burning) the catalyst material results in further improvement of oxidation reduction performance of the catalyst material. Thus, the catalyst material having undergone heat treatment (burning) may have a sufficient catalytic performance required when it is used for fuel cells etc., thereby having serviceability.

In the following the present invention will be described in more detail by examples; however, it is to be understood that the invention is not limited to these examples.

### Example 1

### Preparation Through Electrochemical Polymerization of a Polymerizable Ligand, 2-(1H-Pyrrol-3-Ylpyridine)

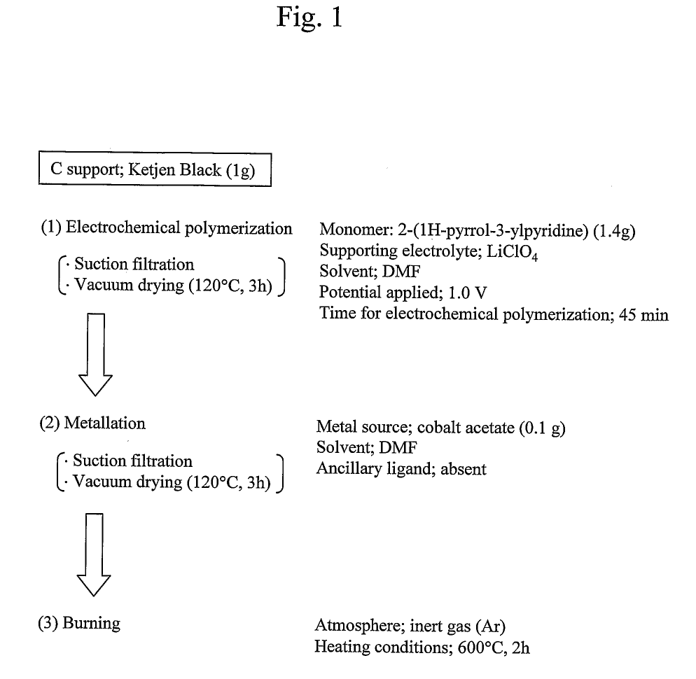

A catalyst material was prepared, following the flow shown in FIG. 1, using 2-(1H-pyrrol-3-ylpyridine) (pyPy), a polymerizable ligand where pyridine, which has a strong coordination property to Co, and pyrrole, which is polymerizable, are bonded together, so that the material had an increased density of “Co—N4 structure”.

### (1) “Electrochemical Polymerization”

In 200 ml of DMF solvent containing 0.1 M LiClO₄ as a supporting electrolyte, was dissolved 1.4 g of 2-(1H-pyrrol-3-ylpyridine) (pyPy) and 1 g of carbon particles (Ketjen). After 30-minute argon deaeration, electrochemical polymerization was performed using a fluidized bed electrode for 45 minutes by constant potential method at an applied voltage of 1.0 to yield poly(2-(1H-pyrrol-3-ylpyridine))-coated carbon particles.

The amount of 2-(1H-pyrrol-3-ylpyridine) used was 10 times larger the amount calculated based on the assumption that poly(2-(1H-pyrrol-3-ylpyridine)) was attached to the surface area (800 m²/g) of Ketjen leaving no space among them.

### (2) “Metallation”

On the poly(2-(1H-pyrrol-3-ylpyridine))-coated carbon particles obtained by the above (1) electrochemical polymerization, cobalt metal was supported in the following manner. Specifically, 2 g of poly(2-(1H-pyrrol-3-ylpyridine))-coated carbon particles and 4.08 g of cobalt acetate were put in a 200 ml eggplant-shaped flask and DMF or methanol was further added thereto. After 30-minute argon deaeration, the mixture was refluxed for 2 hours. The mixture was then subjected to suction filtration to filter off the solid content, and the solid content was vacuum dried at 120° C. for 3 hours to yield carbon particles coated with cobalt-poly(2-(1H-pyrrol-3-ylpyridine)) electrochemically polymerized film complex (catalyst particles).

### (3) “Burning”

The carbon particles coated with cobalt-poly(2-(1H-pyrrol-3-ylpyridine)) electrochemically polymerized film complex (catalyst particles) obtained through the above (2) metallation was heat treated at 600° C. for 2 hours in an atmosphere of argon gas.

Cyclic voltammetry (CV) and rotating disk electrode (RDE) measurements were made for the heat treated catalyst material to measure the peak potential and peak current density.

The measurements were made under the following conditions.

[CV (cyclic voltammetry) and RDE]
(Rotating disk electrode) measurement:

Measuring instruments:
Potentiostat [Nikkou Keisoku, DPGS-1]
Function generator [Nikkou Keisoku, NFG-5]
X-Y recorder [Rikendenshi, D-72DG]

Working electrode:
Edge plane pyrolytic graphite (EPG) electrode

Reference electrode:
Saturated Calomel electrode (SCE)

Counter electrode:
Platinum wire

Supporting electrolyte: 1.0 M HClO₄ aqueous solution

Sweeping range: 600 to −600 mV

Sweeping rate: 100 mV/sec (CV), 10 mV/sec (RDE)

Rotation rate: 100, 200, 400, 600, 900 rpm (RDE)

Measuring method:

In CV measurement for a complex alone, the measurement was made using, as a working electrode, an electrode obtained by dissolving 20 mg of complex in 10 ml of methanol, casting 10 μl of the resultant complex solution over an edge plane pyrolytic graphite (EPG) electrode and further casting 8 μl of the mixed solution of Nafion and 2-propanol over the EPG electrode.

In 250 μl of Nafion solution, 20 mg of carbon-based particles having undergone each treatment was dispersed, and 20 μl of the dispersion was cast over an EPD electrode.

The results of Example 1 are shown in Table 1.

TABLE 1

| | | Peak potential | Peak current | |
|---|---|---|---|---|
| | | Ep | density Ip | |
| Solvent | Burning | [V vs. SCE] | (mA/cm²) | Notes |
| Methanol | Absent | +0.01 | 1.42 | Comparative |
| | | | | Example |
| DMF | Absent | +0.05 | 0.62 | Comparative |
| | | | | Example |
| DMF | Present | +0.20 | 0.89 | Example of the |
| | (600° C.) | | | present invention |

The results shown in Table 1 reveal that in a fuel cell cathode catalyst prepared using 2-(1H-pyrrol-3-ylpyridine) (pyPy), a polymerizable ligand where pyridine, which has a strong coordination property to Co, and pyrrole, which is polymerizable, are bonded together, so that the material has an increased density of “Co—N4 structure”, examining the preparation conditions (solvent used during the coordination of metal and the presence or absence of burning) makes it possible to provide high oxygen reduction potential and a high current density, thereby yielding a highly active catalyst.

The detailed mechanism of increasing the performance of a catalyst material has not been clarified yet at the present time; however, the use of 2-(1H-pyrrol-3-ylpyridine) (pyPy), a polymerizable ligand where pyridine, which has a strong coordination property to Co, and pyrrole, which is polymerizable, are bonded together, possibly enables the catalyst material to support active species densely.

### Example 2

### Preparation Using a Polymerizable Ligand, 2-(1H-Pyrrol-3-Ylpyridine) without Causing Polymerization

To allow a catalyst material to have an increased density of “Co—N4 structure”, 2-(1H-pyrrol-3-ylpyridine) (pyPy), a polymerizable ligand where pyridine, which has a strong coordination property to Co, and pyrrole, which is polymerizable, are bonded together, as a polynuclear complex molecules, was physically adsorbed on a carbon support to develop oxygen reduction activity. A fuel cell cathode catalyst was prepared using this.

The results of Example 2 are shown in Table 2.

TABLE 2

| | | | Peak potential | Peak current | |
|---|---|---|---|---|---|
| Process for supporting | | | Ep | density Ip | |
| catalyst on carbon support | Solvent | Burning | [V vs. SCE] | (mA/cm²) | Notes |
| Electrochemical | DMF | Absent | +0.01 | 1.42 | For comparison |
| polymerization | | | | | |
| Electrochemical | DMF | Present | +0.05 | 0.62 | For comparison |
| polymerization | | (600° C.) | | | |
| Physical adsorption | DMF | Absent | +0.20 | 0.89 | Example of the |
| | | | | | present invention |
| Physical adsorption | DMF | Present | | | Example of the |
| | | (600° C.) | | | present invention |

The results shown in Table 2 reveal that when a polymerizable ligand, 2-(1H-pyrrol-3-ylpyridine) (pyPy), is physically adsorbed on a carbon support, the peak potential, which shows the catalytic activity, is markedly excellent, compared with when a polymerizable ligand, 2-(1H-pyrrol-3-ylpyridine) (pyPy), is electrochemically polymerized on a carbon support. Besides, the peak current density, which shows the reaction rate, is also markedly excellent, compared when the burning is absent.

The reason the catalytic activity described above is improved by the present invention may be that the use of a polymerizable ligand having an electrochemically polymerizable heterocycle and an electron-withdrawing group bonded to the heterocycle allows the support to support a catalytic metal, as an active species, more densely, though they have not been fully clarified yet at the present time. In Example 2, it is considered that probably 2-(1H-pyrrol-3-ylpyridine), where pyridine, which has a strong coordination property to Co etc., and pyrrole, which is electrochemically polymerizable, are bonded to each other, allows the carbon support to support an active species, Co, densely.

### INDUSTRIAL APPLICABILITY

The catalyst material of the present invention is a catalyst material that is allowed to bear a catalytic metal densely by coordinating the catalytic metal to a specified compound, whereby it has an excellent catalytic activity and can improve power generation efficiency when used as a catalyst for fuel cells. Thus, the present invention contributes to spreading the use of fuel cells.

1. A catalyst material, comprising: a conductive material whose surface physically adsorbs a polymerizable ligand having an electrochemically polymerizable heterocycle and an electron-withdrawing group bonded to the heterocycle or is coated with polynuclear complex molecules formed by electrochemical polymerization of the polymerizable ligand having an electrochemically polymerizable heterocycle and an electron-withdrawing group bonded to the heterocycle, wherein a catalytic metal is coordinated to the adsorption layer of the polymerizable ligand having an electrochemically polymerizable heterocycle and an electron-withdrawing group bonded to the heterocycle, or to the coating layer of the polynuclear complex molecules; wherein the polymerizable ligand having an electrochemically polymerizable heterocycle and an electron-withdrawing group bonded to the heterocycle is 2-(1H-pyrrol-3-ylpyridine).

2. (canceled)

3. A process for preparing a catalyst material, comprising the steps of: allowing the surface of a conductive material to physically adsorb a polymerizable ligand having an electrochemically polymerizable heterocycle and an electron-withdrawing group bonded to the heterocycle or to be coated with polynuclear complex molecules formed by electrochemical polymerization of the polymerizable ligand having an electrochemically polymerizable heterocycle and an electron-withdrawing group bonded to the heterocycle; and coordinating a catalytic metal to the adsorption layer of the polymerizable ligand having an electrochemically polymerizable heterocycle and an electron-withdrawing group bonded to the heterocycle or to the coating layer of the polynuclear complex molecules; wherein catalyst material according to claim 1, wherein the polymerizable ligand having an electrochemically polymerizable heterocycle and an electron-withdrawing group bonded to the heterocycle is 2-(1H-pyrrol-3-ylpyridine) and in the electrochemical polymerization step, where 2-(1H-pyrrol-3-ylpyridine) is electrochemically polymerized to yield polynuclear complex molecules and the surface of the conductive material is coated with the polynuclear complex molecules, the potential applied in the electrochemical polymerization is 0.8 to 1.5 V.

4. (canceled)

5. The process for preparing a catalyst material according to claim 3, further comprising a step of burning at 400 to 800° C. in an atmosphere of an inert gas after the catalytic metal coordination step.

6. (canceled)

7. The process for preparing a catalyst material according to claim 3, comprising: an electrochemical polymerization step of electrochemically polymerizing a polymerizable ligand having an electrochemically polymerizable heterocycle and an electron-withdrawing group bonded to the heterocycle to yield a polynuclear polymer so that the surface of a conductive material is coated with the polynuclear polymer derived from the polymerizable ligand; and a metallation step of coordinating a catalytic metal to the coating layer of the polynuclear polymer to form polynuclear complex molecules, wherein the electrochemical polymerization step and/or the metallation step are carried out more than one time.

8. The process for preparing a catalyst material according to claim 3, wherein in the coordination of a catalytic metal, a noble metal and a transition metal are coordinated at the same time.

9. The process for preparing a catalyst material according to claim 3, further comprising a heat treatment step after the coordination of a catalytic metal.

10. The process for preparing a catalyst material according to claim 3, further comprising a step of coordinating a nitrogen-containing low-molecular-weight compound as an ancillary ligand to the catalytic metal.

11. The process for preparing a catalyst material according to claim 10, wherein the nitrogen-containing low-molecular-weight compound is pyridine and/or phenanthroline.

12. The process for preparing a catalyst material according to claim 8, wherein the noble metal is one or more selected from the group consisting of palladium (Pd), iridium (Ir), rhodium (Rh) and platinum (Pt) and the transition metal is one or more selected from the group consisting of cobalt (Co), iron (Fe), molybdenum (Mo) and chromium (Cr).

13. A catalyst for fuel cells, comprising the catalyst material according to claim 1.

14. Fuel cells, comprising, as a catalyst for fuel cells, the catalyst material according to claim 1.
